(19) United States
(12) Patent Application Publication
(10) Pub. No.: US 2022/0106977 A1
(43) Pub. Date: Apr. 7, 2022

(54) Loose-Proof Screw Assembly and Fastened Structure Comprising the Same

(71) Applicant: Telefonaktiebolaget LM Ericsson (publ), Stockholm (SE)

(72) Inventors: Pinghua Duan, Nanjing (CN); Zhen Yang, Nanjing (CN); Pengxiao Ge, Nanjing (CN)

(21) Appl. No.: 17/421,925

(22) PCT Filed: Oct. 24, 2019
(86) PCT No.: PCT/CN2019/113089

§ 371 Date: Jul. 9, 2021

(30) Foreign Application Priority Data
Jan. 11, 2019 (CN) 201920043902.1

(51) Int. Cl. F16B 39/26; F16B 5/02

(52) U.S. Cl. CPC F16B 39/26; F16B 5/0241

(57) ABSTRACT

A loose-proof screw assembly comprises a screw (1) having a head (11) and a shaft (12) and an elastic washer (2) having a central hole (21). The shaft (12) comprises a smooth portion (121) without threads and a threaded portion (122) with threads. The threaded portion (122) is adapted to be screwed into a threaded hole (201) of a base (200) through a through hole (101) of a part (100) to be fixed and the central hole (21) of the elastic washer (2), so as to fasten the part (100) to be fixed onto the base (200). The elastic washer (2) is disposed between the part (100) to be fixed and the base (200), and forms interference fit with the smooth portion (121). A fastened structure is also included. According to the structure described above, loose of screw connection due to vibration or the like can be reliably prevented.

### TECHNICAL FIELD

This disclosure relates to mechanical connection, in particular to a threaded fastener. More specifically, this disclosure relates to a loose-proof screw assembly.

### BACKGROUND

As a mechanical connection that fastens two parts together, threaded fasteners such as screws are widely used in various devices. During operation or transportation of the devices, a threaded connection is prone to become loose due to vibration, impact, or change in load or temperature. To prevent loose of screws, various loose-proof measures have been designed.

FIG. 1 illustrates a conventional loose-proof screw assembly, wherein an elastic washer 2′ and a flat washer 3′ are arranged between a screw 1′ and a part 100′ to be fixed. The elastic washer 2′ can provide a pretightening force, and the flat washer 3′ can increase friction force, a combination of which helps prevent the screw 1′ from loosening.

However, such a conventional loose-proof screw assembly cannot keep the pretightening force for a long time. The main reason is that the direction of the pretightening force F provided by the elastic washer 2′ is the same as the loosening direction of the screw 1′. Once the screw 1′ becomes loose, the pretightening force F will be decreased, and the friction force will also be decreased accordingly; consequently, the screw 1′ is more easily to become even loose. Besides, in the case of multiple screws, loose-proof actions of the screws are independent from each other, and the loose-proof effect cannot be improved through cooperation therebetween.

### SUMMARY

In view of the above technical problem, this disclosure is proposed to provide a threaded connection that can reliably prevent loose.

According to an aspect of this disclosure, there is provided a loose-proof screw assembly, comprising a screw having a head and a shaft, and an elastic washer having a central hole. The shaft of the screw comprises a smooth portion without threads and a threaded portion with threads. The threaded portion is adapted to be screwed into a threaded hole of a base through a through hole of a part to be fixed and the central hole of the elastic washer, so as to fasten the part to be fixed onto the base. In a fastened structure formed thereby, the elastic washer is disposed between the part to be fixed and the base and forms interference fit with the smooth portion of the screw.

In an embodiment of this disclosure, a recessed portion for accommodating the elastic washer is formed on the base, and a height of the elastic washer is greater than a height of the recessed portion.

In an embodiment of this disclosure, the elastic washer comprises an annular flat portion and a bent portion protruding in a direction toward the head of the screw from a periphery of the flat portion. The flat portion defines the central hole and is adapted to abut against the base, and the bent portion is adapted to abut against the part to be fixed.

In an embodiment of this disclosure, the bent portion comprises a plurality of flaps that are separated circumferentially.

In an embodiment of this disclosure, the flat portion and the bent portion are formed integrally by stamping a metal sheet or an engineering plastic sheet.

In an embodiment of this disclosure, a diameter D1 of the smooth portion of the screw, a diameter D2 of the threaded portion of the screw and a diameter D3 of the central hole of the elastic washer satisfy a relation of D1>D3>D2.

In an embodiment of this disclosure, an end of the smooth portion of the screw that is adjacent to the threaded portion is provided with a chamfer.

In an embodiment of this disclosure, the head of the screw is provided with a tool engagement portion in the shape of a line, a cross or a polygon.

According to another aspect of this disclosure, there is provided a fastened structure, comprising a part to be fixed, a base, and a threaded fastener that fastens the part to be fixed onto the base. The threaded fastener is a loose-proof screw assembly according to any of the above.

In an embodiment of this disclosure, the part to be fixed is fastened onto the base by means of a plurality of the loose-proof screw assemblies.

The loose-proof screw assembly according to this disclosure and the fastened structure comprising the same can reliably prevent loose of threaded connection due to vibration or the like.

### BRIEF DESCRIPTION OF THE DRAWINGS

The aforementioned and other aspects, features and advantages in various embodiments of this disclosure become more apparent from the following detailed description with reference to the drawings. In the drawings, identical reference signs or symbols represent identical or equivalent elements. The drawings are not necessarily drawn to scale, in which

FIG. 1 is a schematic diagram of a fastened structure that employs a conventional loose-proof screw assembly;

FIG. 2 is an exploded view of a fastened structure provided in an embodiment of this disclosure;

FIG. 3 is a perspective view of a screw provided in an embodiment of this disclosure;

FIG. 4 is a perspective view of an elastic washer provided in an embodiment of this disclosure;

FIG. 5, FIG. 6, and FIG. 7 are schematic diagrams illustrating the assembly process of a fastened structure provided in an embodiment of this disclosure; and

FIG. 8 is a schematic diagram illustrating the loose-proof action of a loose-proof screw assembly provided in the embodiment of this disclosure.

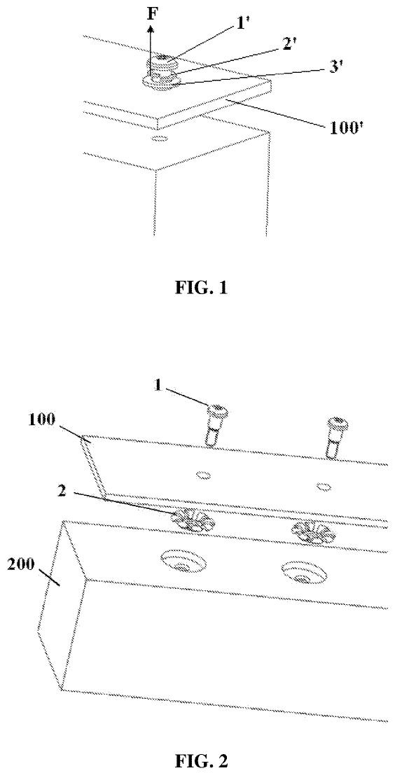

### DETAILED DESCRIPTION OF PREFERRED EMBODIMENTS

In order to make technical solutions and advantages according to embodiments of this disclosure clearer, the technical solutions according to embodiments of this disclosure will be described clearly and completely with reference to the accompanying drawings. Apparently, the described embodiments are merely some but not all of embodiments of this disclosure. All other embodiments that could be obtained on the basis of the described embodiments of this disclosure by those skilled in the art without paying any creative effort shall fall within the scope of the present utility model.

FIG. 2 is an exploded view of a fastened structure provided in an embodiment of this disclosure. As shown in FIG. 2, the fastened structure according to this embodiment comprises a part 100 to be fixed, a base 200, and a plurality of threaded fasteners that fasten the part 100 to be fixed onto the base 200. The threaded fastener is a loose-proof screw assembly comprising a screw 1 and an elastic washer 2. The screw 1 is screwed into a threaded hole formed in the base 200, and usually does not need to be used in conjunction with a nut.

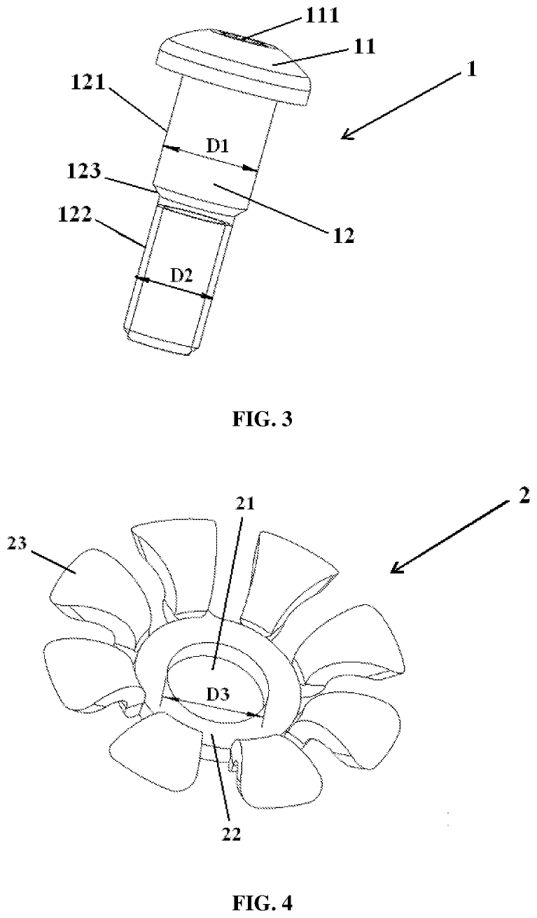

FIG. 3 illustrates an embodiment of the screw 1. As shown in FIG. 3, the screw 1 comprises a head 11 and a shaft 12. A top face of the head 11 is provided with a tool engagement portion 111, which cooperates with a tool, such as a screwdriver or a wrench, to screw the screw 1. The tool engagement portion 111 may take a shape of a line, a cross or a polygon. The shaft 12 comprises a smooth portion 121 without threads and a threaded portion 122 with threads. The smooth portion 121 is between the head 11 and the threaded portion 122. A diameter D1 of the smooth portion 121 is greater than a diameter D2 of the threaded portion 122. An end of the smooth portion 121 that is adjacent to the threaded portion 122 is provided with a chamfer 123. In other embodiments, the chamfer 123 may not be provided, and instead, a step-like transition section may be formed between the smooth portion 121 and the threaded portion 122.

FIG. 4 illustrates an embodiment of the elastic washer 2. The elastic washer 2 has a central hole 21. The shaft 12 of the screw 1 may pass through the central hole 21. A diameter D3 of the central hole 21 is slightly smaller than the diameter D1 of the smooth portion 121, and is greater than the diameter D2 of the threaded portion 122. That is, the diameter D1 of the smooth portion 121, the diameter D2 of the threaded portion 122, and the diameter D3 of the central hole 21 satisfy a relation of D1>D3>D2.

The elastic washer 2 in this embodiment comprises an annular flat portion 22 and a bent portion 23 protruding in a direction toward the head 11 of the screw 1 from a periphery of the flat portion 22. The flat portion 22 defines the central hole 21. The bent portion 23 includes a plurality of flaps that are separated circumferentially. The bent portion 23 is not limited to separated flaps in form, but may be any bent flexible structure. In other embodiments, the bent portion 23 may be continuous in the circumferential direction.

The elastic washer 2 including the flat portion 22 and the bent portion 23 may be formed integrally by stamping a metal sheet (e.g. aluminum sheet or steel sheet). Alternatively, a suitable engineering plastic sheet may be used in place of the metal sheet. The elastic washer 2 in principle may be made of any sheet that meets the requirement of strength. Portions of the sheet between the flaps of the bent portion 23 are cut off at the time of stamping, or before or after the stamping.

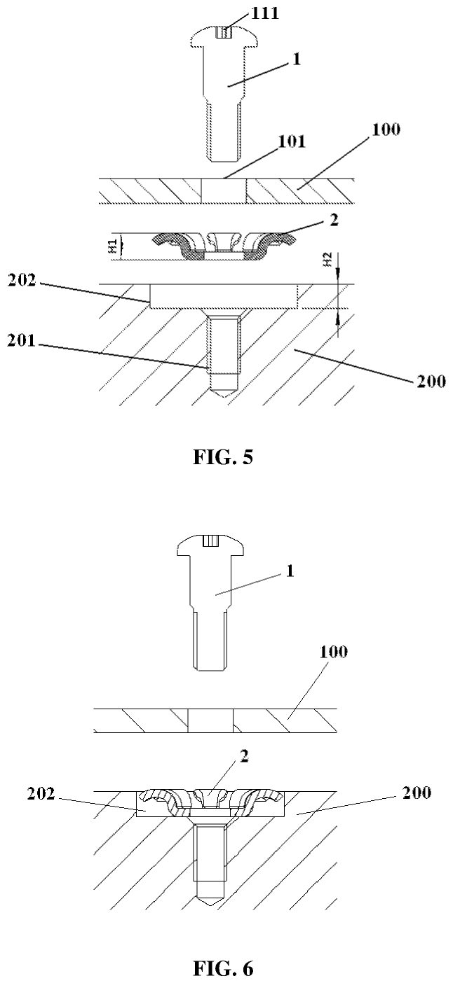

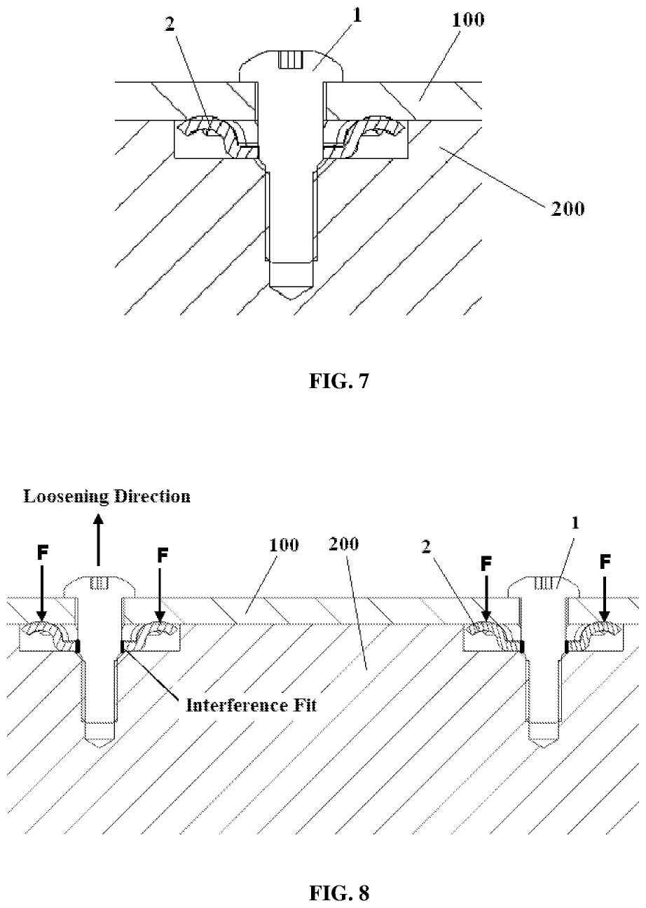

The assembly process of a fastened structure according to an embodiment is described below with reference to FIGS. 5-7.

As shown in FIG. 5, a through hole 101 is formed in the part 100 to be fixed, and a threaded hole 201 is formed in the base 200. A diameter of the through hole 101 is slightly greater than the diameter D1 of the smooth portion 121. The diameter of the threaded hole 201 is substantially identical with the diameter D2 of the threaded portion 122. A recessed portion 202 is formed on a surface of the base 200 that faces the part 100 to be fixed. A height H2 of the recessed portion 202 is slightly smaller than a height H1 of the elastic washer 2. The recessed portion 202 is circular, having a diameter slightly greater than a maximum outer diameter of the elastic washer 2. The threaded hole 201 extends downward from a center of a bottom surface of the recessed portion 202.

At the time of assembling, as shown in FIG. 6, the elastic washer 2 is firstly put into the recessed portion 202 of the base 200, and then the part 100 to be fixed is placed above the base 200, with the through hole 101 of the part 100 to be fixed being aligned with the threaded hole 201 of the base 200. Subsequently, the shaft 12 of the screw 1 is passed through the through hole 101 of the part 100 to be fixed and the central hole 21 of the elastic washer 2, and a tool is used to screw the threaded portion 122 into the threaded hole 201 of the base 200. Thereby, the part 100 to be fixed is fastened onto the base 200 by the screw 1.

The fastened structure after finishing assembly is shown in FIG. 7. The elastic washer 2 is disposed between the part 100 to be fixed and the base 200, with the flat portion 22 thereof abutting against the bottom surface of the recessed portion 202 of the base 200, and the bent portion 23 thereof abutting against a bottom surface of the part 100 to be fixed. Because the height H1 of the elastic washer 2 is greater than the height H2 of the recessed portion 202, the elastic washer 2 is compressed between the part 100 to be fixed and the base 200. The diameter D3 of the central hole 21 of the elastic washer 2 is slightly smaller than the diameter D1 of the smooth portion 121 of the screw 1, so the elastic washer 2 and the smooth portion 121 form interference fit, and it is hard to separate them without the use of a tool. As the diameter D2 of the threaded portion 122 is smaller than the diameter D3 of the central hole 21, the threaded portion 122 can be easily inserted through the central hole 21 of the elastic washer 2 without damaging the threads thereon.

The loose-proof action of the loose-proof screw assembly provided by the embodiments will be described below with reference to FIG. 8. In a case where the screw 1 tends to become loose in a loosening direction due to reasons such as vibration, the screw 1 will not loose unless the pretightening force F applied to the elastic washer 2 by the part 100 to be fixed is overcome or the screw 1 is separated from the elastic washer 2. However, because the elastic washer 2 and the smooth portion 121 of the screw 1 form interference fit, the force produced by, e.g. vibration is insufficient to separate the screw 1 from the elastic washer 2. Moreover, the direction of the pretightening force F applied to the elastic washer 2 by the part 100 to be fixed is opposite to the loosening direction of the screw 1, so when the screw 1 moves in the loosening direction, the elastic washer 2 will be further compressed, thereby producing a larger pretightening force. The larger pretightening force produces a larger friction, thereby reliably preventing the threaded connection from loosening. In a case where multiple loose-proof screw assemblies are employed to fasten the part 100 to be fixed onto the base 200, only when the pretightening forces applied to all the loose-proof screw assemblies are overcome, can the loose-proof screw assemblies move in the loosening direction, and accordingly, the loose-proof screw assemblies can mutually strengthen the loose-proof effect.

Therefore, the loose-proof screw assembly and the fastened structure according to this disclosure can reliably prevent threaded connection from loosening due to vibration and the like.

It should be appreciated that the above embodiments are merely some exemplary embodiments for demonstrating the principle of the present utility model, and the present utility model is not limited thereto. A person of ordinary skill in the art can make various variations and improvements without departing from the spirit and essence of the present utility model, which shall fall within the scope of the present utility model.

1.-10. (canceled)

11. A loose-proof screw assembly comprising:
a screw having a head and a shaft; and
an elastic washer having a central hole;
wherein the shaft comprises a smooth portion without threads and a threaded portion with threads, the threaded portion being adapted to be screwed into a threaded hole of a base through a through hole of a part to be fixed and the central hole of the elastic washer, so as to fasten the part to be fixed onto the base, wherein the elastic washer is disposed between the part to be fixed and the base and forms interference fit with the smooth portion.

12. The loose-proof screw assembly according to claim 11, wherein a recessed portion for accommodating the elastic washer is formed on the base, and a height of the elastic washer is greater than a height of the recessed portion.

13. The loose-proof screw assembly according to claim 11, wherein the elastic washer comprises an annular flat portion and a bent portion protruding in a direction toward the head from a periphery of the flat portion, the flat portion defining the central hole and being adapted to abut against the base, and the bent portion being adapted to abut against the part to be fixed.

14. The loose-proof screw assembly according to claim 13, wherein the bent portion comprises a plurality of flaps separated circumferentially.

15. The loose-proof screw assembly according to claim 13, wherein the flat portion and the bent portion are formed integrally by stamping a metal sheet or an engineering plastic sheet.

16. The loose-proof screw assembly according to claim 11, wherein a diameter D1 of the smooth portion, a diameter D2 of the threaded portion and a diameter D3 of the central hole of the elastic washer satisfy a relation of D1>D3>D2.

17. The loose-proof screw assembly according to claim 16, wherein an end of the smooth portion adjacent to the threaded portion is provided with a chamfer.

18. The loose-proof screw assembly according to claim 11, wherein the head is provided with a tool engagement portion in the shape of a line, a cross or a polygon.

19. A fastened structure comprising:
a part to be fixed;
a base; and
a threaded fastener that fastens the part to be fixed onto the base, wherein the threaded fastener is a loose-proof screw assembly, wherein the loose-proof screw assembly comprises:
a screw having a head and a shaft; and
an elastic washer having a central hole;
wherein the shaft comprises a smooth portion without threads and a threaded portion with threads, the threaded portion being adapted to be screwed into a threaded hole of the base through a through hole of the part to be fixed and the central hole of the elastic washer, so as to fasten the part to be fixed onto the base, wherein the elastic washer is disposed between the part to be fixed and the base and forms interference fit with the smooth portion.

20. The fastened structure according to claim 19, wherein the part to be fixed is fastened onto the base by means of a plurality of loose-proof screw assemblies, wherein each of the plurality of loose-proof screw assemblies comprises:
a screw having a head and a shaft; and
an elastic washer having a central hole;
wherein the shaft comprises a smooth portion without threads and a threaded portion with threads, the threaded portion being adapted to be screwed into a threaded hole of the base through a through hole of the part to be fixed and the central hole of the elastic washer, so as to fasten the part to be fixed onto the base, wherein the elastic washer is disposed between the part to be fixed and the base and forms interference fit with the smooth portion.

21. The fastened structure according to claim 19, wherein a recessed portion for accommodating the elastic washer is formed on the base, and a height of the elastic washer is greater than a height of the recessed portion.

22. The fastened structure according to claim 19, wherein the elastic washer comprises an annular flat portion and a bent portion protruding in a direction toward the head from a periphery of the flat portion, the flat portion defining the central hole and being adapted to abut against the base, and the bent portion being adapted to abut against the part to be fixed.

23. The fastened structure according to claim 22, wherein the bent portion comprises a plurality of flaps separated circumferentially.

24. The fastened structure according to claim 22, wherein the flat portion and the bent portion are formed integrally by stamping a metal sheet or an engineering plastic sheet.

25. The fastened structure according to claim 19, wherein a diameter D1 of the smooth portion, a diameter D2 of the threaded portion and a diameter D3 of the central hole of the elastic washer satisfy a relation of D1>D3>D2.

26. The fastened structure according to claim 25, wherein an end of the smooth portion adjacent to the threaded portion is provided with a chamfer.

27. The fastened structure according to claim 19, wherein the head is provided with a tool engagement portion in the shape of a line, a cross or a polygon.
